(19) United States
(12) Patent Application Publication
(10) Pub. No.: US 2022/0030852 A1
(43) Pub. Date: Feb. 3, 2022

(54) AGROCHEMICAL OIL DISPERSION FORMULATION

(71) Applicant: BASF SE, Ludwigshafen (DE)

(72) Inventors: Claude Taranta, Limbergerhof (DE); Wolfgang Laik, Limburgerhof (DE); Jochen Schreieck, Limburgerhof (DE); Ophelie Zeyons, Ludwigshafen (DE); Christian Sowa, Limburgerhof (DE)

(21) Appl. No.: 17/297,501

(22) PCT Filed: Dec. 4, 2019
(86) PCT No.: PCT/EP2019/083703

§ 371 Date: May 27, 2021

(30) Foreign Application Priority Data
Dec. 21, 2018 (EP) 18215117.5
Apr. 9, 2019 (EP) 19168144.4

(51) Int. Cl. A01N 25/04

(52) U.S. Cl. CPC A01N 25/04

(57) ABSTRACT

The invention relates to an agrochemical formulation comprising a continuous oil phase comprising a water-immiscible solvent; an agrochemical active in the form of particles, which particles are suspended in the continuous oil phase; and water droplets that are emulsified in the continuous oil phase, wherein the agrochemical formulation is substantially free of a thickener. It also relates to a method for preparing the agrochemical formulation, to a method of use of the agrochemical formulation, and to a method for increasing the viscosity of a continuous oil phase comprising the steps of a) providing a continuous oil phase, and b) emulsifying water droplets in the continuous oil phase, wherein the continuous oil phase is substantially free of a thickener.

The invention relates to an agrochemical formulation; a method for producing the agrochemical formulation; a method for preparing the agrochemical formulation; a method for controlling phytopathogenic fungi and/or undesired plant growth and/or undesired attack by insects or mites and/or for regulating the growth of plants, a method for stabilizing an oil dispersion; and a method for increasing the viscosity of a continuous oil-phase. Preferred embodiments are described in the dependent claims. Combinations of embodiments with other embodiments are within the scope of the disclosure.

Many agrochemical actives are formulated as liquid concentrates. If the agrochemical active is not soluble in the liquid, it is often necessary to form a stable and homogeneous suspension of the agrochemical active in the continuous liquid phase. If the continuous liquid phase is an aqueous phase, these formulations are known in the art as suspension concentrates (SCs). If the continuous liquid phase is an oil phase, these formulations are known as oil dispersions (ODs). It is desirable that the applicant does not need to homogenize the liquid concentrate before use, since this will require additional time and handling, including exposure to toxic ingredients that may be present in the agrochemical formulation. A major problem for suspensions of particles is that the particles tend to form sediment over time by particle growth and/or settling of the particles. This tendency may be accompanied by caking of the sediment, i.e. the formation of solid sediment that cannot be easily resuspended by the applicant.

To prevent the formation of sediment (and particle-free serum in the supernatant), thickeners are generally added to suspension concentrates and oil dispersions. The thickeners increase the viscosity of the continuous liquid phase, which reduces the influence of gravitational sedimentation and particle-particle interactions in the suspension.

OD formulations are advantageous as compared to SC formulation in that no expensive biocides, many of those being under regulatory scrutinization (e.g. BIT, MIT, CIT) are required to protect the formulation from infestation by microorganisms and fungi. Unfortunately, the majority of thickeners is not compatible with the continuous oil phases of OD formulations. Either they are not soluble, or cannot be activated in other words are not able to unfold their thickening and/or suspending properties in the lipophilic environment of the continuous oil phases. Other thickeners that are especially designed for lipophilic solvents are often expensive and may interact disadvantageously with other additives or the active ingredients in the formulation. Since oil dispersions are typically applied by dilution in an aqueous tank mix composition by farmers, it is also not only required that the thickener is soluble in the oil phase of the OD formulation, but that they do not create any problems during dilution with water (e.g. by precipitation).

It is thus desirable to find a way to stabilize OD formulations that overcomes the problems encountered with shelf-life stabilization by common thickeners as outlined above. It has now surprisingly been found that emulsified water droplets in the continuous oil phase of OD formulations are able to stabilize the formulations. It is not necessary, or at least to a reduced extent, to add other thickeners to the formulation, thereby avoiding the general problems associated with thickening agents.

The invention thus relates to an agrochemical formulation comprising
a) a continuous oil phase comprising a water-immiscible solvent;
b) an agrochemical active in the form of particles, which particles are suspended in the continuous oil phase; and
c) water droplets that are emulsified in the continuous oily phase;

wherein the agrochemical formulation is substantially free of a thickener.

The agrochemical formulation contains a continuous oil phase. The term “continuous oil phase” is known in the technical field of dispersions and refers to the dispersion medium in which particles or liquids are distributed in. In the present case, the continuous oil phase relates to the liquid in which both the water droplets and the agrochemical active is dispersed in.

The continuous oil phase comprises a water-immiscible solvent. The water immiscible solvent typically has a water-solubility of up to 50 g/l, preferably up to 20 g/l, more preferably up to 10 g/l, most preferably up to 1 g/l, and especially preferably up to 0.5 g/l at 20° C.

Suitable examples for water-immiscible solvents are

a hydrocarbon solvent such aliphatic, cyclic and aromatic hydrocarbons (e. g. toluene, xylene, paraffin, tetrahydronaphthalene, alkylated naphthalenes or their derivatives, mineral oil fractions of medium to high boiling point (such as kerosene, diesel oil, coal tar oils));
vegetable oils, such as corn oil, rapeseed oil;
fatty acid esters such as C₁-C₁₀-alkylester of a C₁₀-C₂₂-fatty acid; or

methyl- or ethyl esters of vegetable oils such as rapeseed oil methyl ester or corn oil methyl ester. Mixtures of aforementioned solvents are also possible. In one embodiment, the water-immiscible solvent is a vegetable oil. In another embodiment, the solvent is a hydrocarbon. In another embodiment, the water-immiscible solvent is a fatty acid ester. Particularly preferred water-immiscible solvents are soybean oil, methylated soybean oil, hydrocarbon solvents selected from aliphatic and cyclic hydrocarbons, or mixtures thereof. The continuous oil phase, in particular the water-insoluble solvent contained therein, may also function as a biological adjuvant for the agrochemical active, i.e. the biological efficacy of the agrochemical active may be increased by the continuous oil phase.

The agrochemical formulation typically contains at least 20 wt % of the water-immiscible solvent, preferably at least 30 wt %, more preferably at least 40 wt %, most preferably at least 50 wt % based on the total weight of the agrochemical formulation. The agrochemical formulation may contain up to 95 wt % of the water-immiscible solvent, preferably up to 90 wt %, more preferably up to 85 wt %, most preferably up to 70 wt&, and especially preferably up to 60 wt %. Typically, the agrochemical formulation contains the water-immiscible solvent in a concentration of from 10 to 95 wt %, preferably of from 20 to 80 wt %, more preferably of from 30 to 60 wt % based on the total weight of the agrochemical formulation.

The continuous oil phase may comprise additional water-soluble solvents. The term “water-soluble solvents” does not comprise water per se and refers to organic solvents that have a certain solubility in water. The water-solubility of these additional solvents may be at least 50 g/l, preferably at least 100 g/l, more preferably at least 150 g/l, most preferably at least 200 g/l at 20° C. Typical water-soluble solvents are propylene carbonate, dimethylcarbonate, ethylene carbonate, acetone, gamma-butyrolactone, tetrahydrofuran, N-methyl-2-pyrrolidon, acetonitrile, nitromethane, dimethyl formamide, dimethylacetamide, dimethylsulfoxide, sulfolane, and alcohols such as methanol, ethanol and isopropanol. Typically, the agrochemical formulation does not contain any additional water-soluble solvents. In one embodiment, the agrochemical formulation contains less than 10 wt %, preferably less than 1 wt %, more preferably less than 0.1 wt % of an additional water-soluble solvent based on the total weight of the total weight of the agrochemical formulation.

The agrochemical formulation contains an agrochemical active. The term “agrochemical active” refers to a substance that confers a desirable biological activity to the agrochemical formulation. Typically, the agrochemical active is a pesticide. Agrochemical actives may be selected from fungicides, insecticides, nematicides, herbicides, safeners, micronutrients, biopesticides and/or growth regulators. In one embodiment, the agrochemical active is an insecticide. In another embodiment, the agrochemical active is a fungicide, preferably metyltetraprole. In yet another embodiment the agrochemical active is a herbicide, preferably saflufenacil. In yet another embodiment, the agrochemical active is trifludimoxazin. The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas. Suitable plant growth regulators are antiauxins, auxins, cytokinins, defoliants, ethylene modulators, ethylene releasers, gibberellins, growth inhibitors, morphactins, growth retardants, growth stimulators, and further unclassified plant growth regulators. Suitable micronutrients are compounds comprising boron, zinc, iron, copper, manganese, chlorine, and molybdenum. Suitable nitrification inhibitors are linoleic acid, alpha-linolenic acid, methyl pcoumarate, methyl ferulate, methyl 3-(4-hydroxyphenyl) propionate (MHPP), Karanjin, brachialacton, p-benzoquinone sorgoleone, 2-chloro-6-(trichloromethyl)-pyridine (nitrapyrin or N-serve), dicyandiamide (DCD, DIDIN), 3,4-dimethyl pyrazole phosphate (DMPP, ENTEC), 4-amino-1,2,4-triazole hydrochloride (ATC), 1-amido-2-thiourea (ASU), 2-amino-4-chloro-6-methylpyrimidine (AM), 2-mercapto-benzothiazole (MBT), 5-ethoxy-3-trichloromethyl-1,2,4-thiodiazole (terrazole, etridiazole), 2-sulfanilamidothiazole (ST), ammoniumthiosulfate (ATU), 3-methylpyrazol (3-MP), 3,5-dimethylpyrazole (DMP), 1,2,4-triazol thiourea (TU), N-(1H-pyrazolyl-methyl)acetamides such as N-((3(5)-methyl-1H-pyrazole-1-yl)methyl)acetamide, and N-(1H-pyrazolyl-methyl)formamides such as N-((3(5)-methyl-1H-pyrazole-1-yl)methyl formamide, N-(4-chloro-3(5)-methyl-pyrazole-1-ylmethyl)-formamide, N-(3(5),4-dimethyl-pyrazole-1-ylmethyl)-formamide, neem, products based on ingredients of neem, cyan amide, melamine, zeolite powder, catechol, benzoquinone, sodium terta board, zinc sulfate, 2-(3,4-dimethyl-1H-pyrazol-1-yl)succinic acid (referred to as “DMPSA1” in the following) and/or 2-(4,5-dimethyl-1H-pyrazol-1-yl)succinic acid (referred to as “DMPSA2” in the following), and/or a derivative thereof, and/or a salt thereof; glycolic acid addition salt of 3,4-dimethyl pyrazole (3,4-dimethyl pyrazolium glycolate, referred to as “DMPG” in the following), and/or an isomer thereof, and/or a derivative thereof; citric acid addition salt of 3,4-dimethyl pyrazole (3,4-dimethyl pyrazolium citrate, referred to as “DMPC” in the following), and/or an isomer thereof, and/or a derivative thereof; lactic acid addition salt of 3,4-dimethyl pyrazole (3,4-dimethyl pyrazolium lactate, referred to as “DMPL” in the following), and/or an isomer thereof, and/or a derivative thereof; mandelic acid addition salt of 3,4-dimethyl pyrazole (3,4-dimethyl pyrazolium mandelate, referred to as “DMPM” in the following), and/or an isomer thereof, and/or a derivative thereof; 1,2,4-triazole (referred to as “TZ” in the following), and/or a derivative thereof, and/or a salt thereof; 4-Chloro-3-methylpyrazole (referred to as “CIMP” in the following), and/or an isomer thereof, and/or a derivative thereof, and/or a salt thereof; a reaction adduct of dicyandiamide, urea and formaldehyde, or a triazonyl-formaldehyde-dicyandiamide adduct; 2-cyano-1-((4-oxo-1,3,5-triazinan-1-yl)methyl)guanidine, 1-((2-cyanoguanidino)methyl)urea; 2-cyano-1-((2-cyanoguanidino)methyl)-guanidine; 3,4-dimethyl pyrazole phosphate; allylthiourea, and chlorate salts. Examples of envisaged urease inhibitors include N-(n-butyl) thiophosphoric acid triamide (NBPT, Agrotain), N-(n-propyl) thiophosphoric acid triamide (NPPT), 2-nitrophenyl phosphoric triamide (2-NPT), further NXPTs known to the skilled person, phenylphosphorodiamidate (PPD/PPDA), hydroquinone, ammonium thiosulfate, and mixtures of NBPT and NPPT (see e.g. U.S. Pat. No. 8,075,659). Such mixtures of NBPT and NPPT may comprise NBPT in amounts of from 40 to 95% wt.-% and preferably of 60 to 80% wt.-% based on the total amount of active substances. Such mixtures are marketed as LIMUS, which is a composition comprising about 16.9 wt.-% NBPT and about 5.6 wt.-% NPPT and about 77.5 wt.-% of other ingredients including solvents and adjuvants.

The agrochemical formulation may comprise the agrochemical active in a concentration of at least 1 wt %, preferably at least 5 wt % more preferably at least 10 wt %, most preferably at least 25 wt %, and in particular at least 40 wt % based on the total weight of the agrochemical formulation. The agrochemical formulation may comprise the agrochemical active in a concentration of up to 70 wt %, preferably up to 60 wt %, more preferably up to 50 wt % based on the total weight of the agrochemical formulation. The agrochemical formulation may comprise the agrochemical active in a concentration of from 1 to 70 wt %, preferably 1 to 60 wt %, more preferably 5 to 50 wt % based on the total weight of the composition.

The agrochemical active has a very low solubility in the continuous oil phase. Since the continuous oil phase is very lipophilic, the solubility of the agrochemical active is best measured in a lipophilic hydrocarbon such as n-octane. The agrochemical active typically has a solubility in n-octane at 20° C. of up to 1 g/l, preferably up to 10 mg/l, most preferably up to 100 μg/l. The agrochemical active typically also has a very low water-solubility of up to 10 g/l, preferably up to 5 g/l at 20° C.

The agrochemical active is present in the form of particles that are suspended in the continuous oil phase. The particles can be characterized by their size distributions, which can be determined by dynamic light scattering methods. The D50-value is a statistical figure that indicates a maximum particle diameter that characterizes 50% by volume of all particles. In other words, 50% (v/v) of all particles have a diameter that is equal or smaller than the D50 value. The D50 value for the particles in the instant case is typically up to 30 μm, preferably up to 25 μm, more preferably up to 20 μm, most preferably up to 10 μm, and especially preferably up to 7 μm. The D50 value for the particles is typically at least 0.1 μm, preferably at least 0.8 μm, more preferably at least 1 μm. The D50 value for the particles is typically from 0.5 to 10 μm, preferably from 1 to 8 μm, more preferably from 1.5 to 5 μm.

The agrochemical formulation may also comprise a further agrochemical active in the emulsified water droplets. The further agrochemical active may be selected from fungicides, insecticides, nematicides, herbicides, safeners, micronutrients, biopesticides and/or growth regulators. In one embodiment, the further agrochemical active is an insecticide. In another embodiment, the further agrochemical active is a fungicide. In yet another embodiment the further agrochemical active is a herbicide, preferably dicamba, more preferably a salt of dicamba.

The further agrochemical active is typically water-soluble. The further agrochemical active may have a water-solubility at 20° C. of at least 10 g/l, preferably at least 50 g/l, more preferably at least 100 g/l. Usually, the further agrochemical active is present in dissolved form in the emulsified water droplets.

The agrochemical formulation may comprise the further agrochemical active in a concentration of from 1 to 30 wt %, preferably 1 to 20 wt %, most preferably 1 to 15 wt % based on the total weight of the agrochemical formulation. The agrochemical formulation may comprise the further agrochemical active in a concentration of at least 2 wt %, preferably at least 5 wt % based on the total weight of the agrochemical formulation. The agrochemical formulation may comprise the further agrochemical active in a concentration of up to 25 wt %, preferably up to 10 wt % based on the total weight of the agrochemical formulation.

The agrochemical formulation contains water droplets that are emulsified in the continuous oil phase. The agrochemical formulation typically contains at least 1 wt % of water in the form of water droplets, preferably at least 3 wt % of water in the form of droplets, more preferably at least 5 wt % of water in the form of droplets, most preferably at least 10 wt % of water in the form of droplets, especially preferably at least 15 wt % of water in the form of droplets, and in particular at least 20 wt % of water in the form of droplets, e.g. at least 23 wt % of water in the form of water droplets. The agrochemical formulation typically contains up to 50 wt % of water in the form of water droplets, preferably up to 40 wt % of water in the form of droplets, more preferably up to 30 wt % of water in the form of droplets. The agrochemical formulation typically contains from 1 to 60 wt % of water in the form of water droplets, preferably from 1 to 50 wt % of water in the form of droplets, more preferably from 3 to 30 wt % of water in the form of droplets, most preferably from 10 to 30 wt %, utmost preferably from 15 to 30 wt %, especially from 20 to 30 wt %, and in particular from 22 to 28 wt %. In one embodiment, the agrochemical formulation contains from 15 to 40 wt % of water in the form of droplets. In another embodiment, the agrochemical formulation contains from 20 to 35 wt % of water in the form of droplets. In another embodiment, the agrochemical formulation contains from 22 to 30 wt % of water in the form of droplets.

The water droplets may be characterized by their size distribution similarly to the particles comprising the agrochemical active. The D50 value for the water droplets is typically up to 50 μm, preferably up to 40 μm, more preferably up to 30 μm, most preferably up to 20 μm, and especially preferably up to 10 μm, such as up to 5 μm. The D50 value for the water droplets is typically at least 0.1 μm, preferably at least 0.8 μm, more preferably at least 1 μm. The D50 value for the water droplets is typically from 0.5 to 50 μm, preferably from 1 to 30 μm, more preferably from 1.5 to 20 μm.

The water droplets are emulsified in the continuous oil phase. To this end, the agrochemical formulation typically contains a water-in-oil emulsifier (W/O-emulsifier). Such emulsifiers are generally known to the skilled person. They may be characterized by their “hydrophilic-lipophilic balance” values (“HLB value”) as described by Michael E. Aulton, Pharmaceutics—The Science of Dosage Form Design, Second Edition, Churchill Livingston, 2001, p.95-99. The HLB value of the W/O emulsifier is typically from 1 to 12, more preferably from 1 to 11, most preferably from 1 to 10. The HLB value of the W/O-emulsifier may be up to 9, preferably up to 7. Typically, the W/O-emulsifier is a non-ionic amphoteric emulsifier, preferably containing a polyethylene oxide moiety.

Suitable W/O emulsifiers may be selected from fatty alcohol alkoxylates, preferably ethoxylated C₁₂-C₁₈ alcohols, such as isotridecyl alcohol that is ethoxylated with two ethylene oxide moieties (e.g. the Lutensol TO series of BASF); polyalkoxylates, preferably copolymers of ethylene oxide and propylene oxide (e.g. Step Flow LF or Genapol PF10); copolymers and block copolymers of glycerol with hydroxylated saturated and unsaturated fatty acids, such as polyglyceryl-2 dipolyhydroxystearate (e.g. Dehymuls PGPH), ethoxylated glycerol esters of hydroxy fatty acids and their derivatives, such as ethoxylated castor oil, ethoxylated and hydrogenated castor oil, or ethoxylated castor oil oleate (e.g. Toxium 8248, Toximul 8243, Alkamuls V02003 or Emulsogen EL0200); polyether siloxanes (e.g. Break Thru OE 440), nonionic modified polyesters (e.g. Tersperse 2520), or polyglycerol fatty acid partial esters (e.g. Tego XP11041).

The agrochemical formulation comprises the W/O-emulsifier typically in a concentration of at least 1 wt %, preferably at least 2 wt %, more preferably at least 3 wt % based on the total weight of the agrochemical formulation. The agrochemical formulation may comprise the W/O emulsifier in a concentration of up to 20 wt %, preferably up to 15 wt %, more preferably up to 10 wt %, most preferably up to 8 wt % based on the total weight of the agrochemical formulation. The agrochemical formulation may comprise the W/O emulsifier in a concentration of from 1 to 12 wt %, preferably 1 to 10 wt %, more preferably 2 to 7 wt % based on the total weight of the agrochemical formulation.

The weight ratio of the W/O-emulsifier to the water that is in the form of emulsified water droplets is typically from 1:10 to 1:1, preferably from 1:10 to 1:2, more preferably from 1:6 to 1:2.

Since most applicants dilute the agrochemical formulation in an aqueous tank-mix composition, it is advantageous to add an oil-in-water emulsifier (O/W-emulsifier) to the agrochemical formulation. Such emulsifiers are also generally known to the skilled person. The HLB value of the O/W-emulsifier is typically from 7 to 17, more preferably from 8 to 16, most preferably from 10 to 16. The HLB value of the W/O-emulsifier may be up to 19, preferably up to 18. The HLB value of the W/O-emulsifier may be at least 9, preferably at least 10, more preferably at least 11.

Examples of suitable O/W-emulsifiers are ethoxylated sorbitans partial esters and peresters, preferably ethoxylated sorbitans oleates (e.g. Tween 85 or Arlatone TV), alkoxylated fatty alcohols and alkyl-aryl-sulfonates or mixtures thereof (e.g. Atlox 3467), ethoxylated glycerol esters of hydroxy fatty acids and their derivatives, such as ethoxylated castor oil, ethoxylated and hydrogenated castor oil, or ethoxylated castor oil oleate (e.g. Alkamuls VO 2003), N-hydroxyalkyl amides of saturated and unsaturated fatty acids, preferably N,N-bisdihydroxyethyl amides of saturated and unsaturated fatty acids (e.g. Surfom OD 8104).

The agrochemical formulation comprises the O/W-emulsifier typically in a concentration of at least 1 wt %, preferably at least 2 wt %, more preferably at least 3 wt % based on the total weight of the agrochemical formulation. The agrochemical formulation may comprise the O/W-emulsifier in a concentration of up to 20 wt %, preferably up to 15 wt %, more preferably up to 10 wt %, most preferably up to 8 wt % based on the total weight of the agrochemical formulation. The agrochemical formulation may comprise the O/W-emulsifier in a concentration of from 1 to 12 wt %, preferably 1 to 10 wt %, more preferably 2 to 7 wt % based on the total weight of the agrochemical formulation.

The weight ratio of the O/W-emulsifier to the water-immiscible solvent in the agrochemical formulation is typically from 1:1 to 1:20, preferably from 1:5 to 1:15, more preferably from 1:7 to 1:12.

The agrochemical formulation also typically comprises a dispersant. Suitable dispersants are compounds that have a high affinity to the agrochemical active without dissolving it in the continuous oil phase. The dispersant is typically non-ionic and readily dissolvable in the continuous oil phase.

Examples of suitable dispersants are N-hydroxyalkyl amides of saturated and unsaturated fatty acids, preferably N,N-bisdihydroxyethyl amides of saturated and unsaturated fatty acids (e.g. Surfom OD 8104); ethoxylated sorbitans partial esters and peresters, preferably ethoxylated sorbitans oleates (e.g. Atlas G 1096, Atlas G 1086, or Arlatone TV); ethoxylated glycerol esters of hydroxy fatty acids and their derivatives, such as ethoxylated castor oil, ethoxylated and hydrogenated castor oil, or ethoxylated castor oil oleate (e.g. Alkamuls VO 2003); and alkoxylated fatty alcohols and alkyl-aryl-sulfonates or mixtures thereof (e.g. Atlox 3467), fatty alcohol alkoxylates, preferably ethoxylated C₈-C₁₈ alcohols, such as ethoxylated isodecyl and isododecyl alcohol (e.g. Foryl 5999, Lutensol ON 50, Tensiofix NTM, or Tensiofix 96DB10), and alkoxylated polyolefins, such as polyisobutylene succinic anhydride-polyethylene glycol (e.g. Atlox 4914)

The agrochemical formulation typically contains the dispersant in a concentration of from at least 1 wt %, preferably at least 3 wt %, more preferably at least 5 wt %, most preferably at least 10 wt % based on the total weight of the agrochemical formulation. The agrochemical formulation may contain the dispersant in a concentration of up to 20 wt %, preferably up to 15 wt %, more preferably up to 12 wt % based on the total weight of the agrochemical formulation. The agrochemical formulation may contain the dispersant in a concentration of from 1 to 20 wt %, preferably 5 to 15 wt % based on the total weight of the agrochemical formulation.

The O/W-emulsifiers, W/O-emulsifiers and dispersants as described above are all part of the generic class of surfactants. and do not form clearly distinguishable functional groups within this class. Instead, the skilled person knows that these groups of surfactants may overlap and that certain compounds may be suitable to be included for more than one function, e.g. some dispersants may also act as an O/W-emulsifier.

The total concentration of surfactant, i.e. the sum of dispersants, O/W-emulsifiers, and W/O-emulsifiers, is typically at least 5 wt %, preferably at least 10 wt %, more preferably at least 15 wt %, most preferably at least 20 wt % based on the total weigh of the agrochemical composition. The total concentration of surfactant may be up to 40 wt %, preferably up to 30 wt %, more preferably up to 25 wt % based on the total weight of the agrochemical formulation. The total concentration of surfactant may be from 10 to 35 wt %, preferably from 15 to 30 wt % based on the total weight of the agrochemical formulation.

The agrochemical formulation may comprise
a) a continuous oil phase comprising a water-immiscible solvent;
b) an agrochemical active in the form of particles, which particles are suspended in the continuous oil phase;
c) water droplets that are emulsified in the continuous oil phase; and
d) a water-in-oil emulsifier.
   In one embodiment, the agrochemical formulation comprises
a) a continuous oil phase comprising a water-immiscible solvent;
b) an agrochemical active in the form of particles, which particles are suspended in the continuous oil phase;
c) water droplets that are emulsified in the continuous oil phase; and
d) a water-in-oil emulsifier; and
e) a dispersant.
   In another embodiment, the agrochemical formulation comprises
a) a continuous oil phase comprising a water-immiscible solvent;
b) an agrochemical active in the form of particles, which particles are suspended in the continuous oil phase;
c) water droplets that are emulsified in the continuous oil phase; and
d) a water-in-oil emulsifier;
e) a dispersant; and
f) an oil-in-water emulsifier.
   The agrochemical formulation may comprise
a) 20 to 90 wt % of water-immiscible solvent;
b) 1 to 70 wt % of an agrochemical active in the form of particles, which particles are suspended in the continuous oil phase;
c) 1 to 50 wt % of water droplets that are emulsified in the continuous oil phase;
   each concentration based on the total weight of the agrochemical formulation.
   In one embodiment, the agrochemical formulation comprises
a) 20 to 80 wt % of a continuous oil phase comprising a water-immiscible solvent;
b) 1 to 60 wt % of an agrochemical active in the form of particles, which particles are suspended in the continuous oil phase;
c) 3 to 30 wt % of water droplets that are emulsified in the continuous oil phase;
   each concentration based on the total weight of the agrochemical formulation.

The agrochemical formulation is prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Typically, the water-immiscible solvent and the agrochemical active are contacted in a first step a) to form a premix. The contacting may be achieved by mixing, shaking, or just by adding the agrochemical active to the water-immiscible solvent.

In subsequent step b), the premix is milled to form a raw suspension of the agrochemical active. The milling may be done in typical milling devices, such as ball mills, bead mills, rod mills, semi- and autogenous mills, pebble mills, grinding roll mills, Buhrstone mills, tower mills, hammer mills, planetary mills, vertical-shaft-impactor mills, colloid mills, cone mills, disk mills, edge mills, jet mills, pellet mills, stirred mills, three roll mills, vibratory mills, Wiley mills or similar milling and grinding devices known by the skilled person.

In step c), water is then emulsified in the raw suspension of step b). Step c) typically comprises the sub-steps c1) of addition of water to the raw suspension, followed by c2) the formation of water droplets in the continuous oil phase by emulsification. Emulsification may be achieved by intense mixing, shaking, or milling in dispersing devices. To facilitate the emulsification of the water in the continuous oil phase, a W/O-emulsifier may be added in any step of the method for preparing the agrochemical formulation. Preferably, the W/O-emulsifier is added before step c2). The W/O-emulsifier may be added in step a), step b), or step c). If the W/O-emulsifier is added in step c), it may be added with the water.

A dispersant and/or an O/W-emulsifier may be added in any of steps a), b), or c). Typically, the dispersant is added before or during the milling in step b). The O/W-emulsifier may preferably be added in step a) or step b).

The invention also relates to a method for stabilizing an oil dispersion comprising the step of a) providing a continuous oil phase containing solid particles dispersed therein; and b) emulsifying water droplets in the continuous oil phase; wherein the oil dispersion is substantially free of a thickener

The term “increasing the stability” usually refers to the physical stability of the dispersion, e.g. an improvement of the settling behaviour of the dispersed particles.

The invention also relates to a method for increasing the viscosity (preferably the dynamic viscosity) of a continuous oil phase (preferably of an oil dispersion) comprising the steps of a) providing a continuous oil phase; and b) emulsifying water droplets in the continuous oil phase, wherein the continuous oil phase is substantially free of a thickener.

Suitable means and methods for emulsifying the water-droplets in the continuous oil phase are as outlined above. Typically, the method comprises adding a W/O-emulsifier.

The method for stabilizing an oil dispersion and the method for increasing the viscosity of a continuous oil phase do neither contain the addition of a thickener to the oil dispersion or the continuous oil phase, nor does the oil dispersion nor the continuous oil phase contain a thickener from the start.

The invention also relates to the use of emulsified water droplets to increase the viscosity (preferably the dynamic viscosity) of an oil dispersion, in particular if the oil dispersion is substantially free of a thickener.

The agrochemical formulation may comprise further auxiliaries. Suitable auxiliaries solid carriers or fillers, surfactants, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, UV filters, tackifiers and binders.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, non-ionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl-naphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable non-ionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Typically, the agrochemical formulation is substantially free of a thickener. The term “substantially free” as used herein typically relates to an agrochemical formulation comprising a thickeners to a concentration of not more than 1 wt %, more preferably not more than 0.1 wt %, most preferably not more than 0.01 wt %, each time based on the total weight of the agrochemical composition. In one embodiment, the agrochemical formulation does not contain a thickener.

The term “thickener(s)” usually refers to inorganic clays (organically modified or unmodified), such as bentonintes, hectorite and smectite clays, and silicates (e.g. colloidal hydrous magnesium silicate, colloidal hydrous aluminium silicate, colloidal hydrous aluminium magnesium silicate, hydrous amorphous silicon dioxide); and organic clays, such as polycarboxylates (e.g. poly(meth)acrylates and modified poly(meth)acrylates), polysaccharides (e.g. xanthan gum, agarose, rhamsan gum, pullulan, tragacanth gum, locust bean gum, guar gum, tara gum, Whelan cum, casein, dextrin, diutan gum, cellulose, ethylcellulose, hydroxyethylcellulose, methylhydroxypropylcellulose), polyvinyl ethers, polyvinyl pyrrolidone, polypropylene oxide—polyethylene ocide condensates, polyvinyl acetates, maleic anhydrides, polypropylene glycols, polyacrylonitrile block copolymers, proteins, and carbohydrates.

The skilled person is aware that thickening effects of thickeners depend on the physico-chemical nature of a given liquid composition as compared to the molecular structure of a thickener. If the thickener predominantly contains polar functional groups, such as OH, COOH or SO₃H, the skilled person understands that such a thickener is predominantly applicable in polar, preferably protic solvents. Most prominently, xanthan gum and other non-modified polysaccharides are only able to unfold their full thickening of a liquid composition, if water or other protic solvents are added to the composition. On the other hand, if the thickener contains substantial hydrophobic moieties, it may be suitable for increasing the viscosity of non-polar solvents, such as in the case of dibutyl-lauroyl-glutamide. The skilled person is capable to identify thickeners that increase the viscosity of any given liquid composition by comparing the molecular structure of the thickener with the physico-chemical properties of the liquid composition.

On a functional level, the term “thickener” as used herein refers to a compound that increases the dynamic viscosity of a liquid composition if added, as compared to the same liquid composition without the compound.

A thickener may be defined as a compound that increases the dynamic viscosity of water of at least 0.1 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 0.5 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 1 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 5 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 10 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 25 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 50 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 100 mPas at 25° C. and at a shear rate of 100/second, if the thickener is added at to the water at a concentration of 1 wt %, wherein the water has a standard water hardness according to CIPAC of 342 ppm and a pH of 6.0-7.0. In one embodiment, the thickener increases the dynamic viscosity of water of at least 250 mPas at 25° C. and at a shear rate of 100/second, if the thickener is added at to the water at a concentration of 1 wt %, wherein the water has a standard water hardness according to CIPAC of 342 ppm and a pH of 6.0-7.0.

A thickener may also be defined as a compound that increases the dynamic viscosity of soybean oil methyl ester of at least 0.1 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 0.5 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 1 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 5 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 10 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 25 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 50 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 100 mPas at 25° C. and at a shear rate of 100/second, if the thickener is added at to the soybean oil methyl ester at a concentration of 1 wt %. In one embodiment, the thickener increases the dynamic viscosity of soybean oil methyl ester of at least 250 mPas at 25° C. and at a shear rate of 100/second, if the thickener is added at to the soybean oil methyl ester at a concentration of 1 wt %.

A thickener may be defined as a compound that increases the dynamic viscosity of water or soybean oil methyl ester of at least 0.1 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0. In one embodiment, the thickener increases the dynamic viscosity of water or soybean oil methyl ester of at least 0.5 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0. In one embodiment, the thickener increases the dynamic viscosity of water or soybean oil methyl ester of at least 1 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0. In one embodiment, the thickener increases the dynamic viscosity of water or soybean oil methyl ester of at least 5 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0. In one embodiment, the thickener increases the dynamic viscosity of water or soybean oil methyl ester of at least 10 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

In one embodiment, the thickener increases the dynamic viscosity of water or soybean oil methyl ester of at least 25 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0. In one embodiment, the thickener increases the dynamic viscosity of water or soybean oil methyl ester of at least 50 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0. In one embodiment, the thickener increases the dynamic viscosity of water or soybean oil methyl ester of at least 100 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0. In one embodiment, the thickener increases the dynamic viscosity of water or soybean oil methyl ester of at least 250 mPas at 25° C. and at a shear rate of 100/second, if the thickener is added at to the water or the soybean oil methyl ester at a concentration of 1 wt %, wherein the water has a standard water hardness according to CIPAC of 342 ppm and a pH of 6.0-7.0.

For the avoidance of doubt, the term “thickener” does not relate to the water droplets that are emulsified in the continuous oil phase.

The dynamic viscosity according to the invention is usually measured by means of a Brookfield viscosimeter, i.e. a rotational viscosimeter with a cone-plate geometry. The dynamic viscosity may be determined according to industry standard EN ISO 2555:2018. Usually, the dynamic viscosity is measured at 25° C. In this method, the shear rate of the rotation viscosimeter is constantly increased and the shear stress is measured. For Newtonian Fluids, the measurement results in a linear dataset according to a direct proportionality between the shear stress and the shear rate. For non-Newtonian fluids, the measurement results in a non-linear dependency between shear stress and shear rate. The dynamic viscosity, also called apparent viscosity, is typically determined by measuring the slope of a line through the origin of the coordinate system and the shear stress as determined at a shear rate of 100/second. The true viscosity, which may be different from the apparent viscosity for non-Newtonian fluids, is determined by calculating the slope of the tangent of the experimental curve as measured at a shear rate of 100/second.

The agrochemical formulation usually has a true viscosity of from 60 mPas to 1000 mPas, preferably from 60 mPas to 900 mPas, more preferably from 80 to 800 mPas. The agrochemical formulation usually has an apparent viscosity of from 80 mPas to 2000 mPas, preferably from 100 mPas to 1500 mPas, more preferably from 150 mPas to 1000 mPas, most preferably from 200 mPas to 800 mPas.

Suitable bactericides are bronopol and isothiazolinone derivatives such as alkylisothiazolinones and benzisothiazolinones.

Suitable anti-freezing agents are ethylene glycol, propylene glycol, urea and glycerin. Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

The term “UV filters” is understood as meaning inorganic or organic substances which are able to absorb ultraviolet rays and give off the absorbed energy again in the form of longerwave radiation, e.g. heat. The term “UV filter” relates to one type or a mixture of different types of said compounds. Suitable examples of UV filters are a) benzotriazoles, such as 2-(2H-benzotriazol-2-yl)-4,6-bis(1-methyl-1-phenylethyl)phenol (Tinuvin® 900, CIBA AG), [3-[3-(2H-benzotriazol-2-yl)-5-(1,1-dimethylethyl)-4-hydroxyphenyl]-1-oxopropyl]-w-[3-[3-(2Hbenzotriazol-2-yl)-5-(1,1-dimethylethyl)-4-hydroxyphenyl]-1-oxopropoxy]poly(oxy-1,2-ethanediyl) (Tinuvin® 1130, CIBA AG), 6-tert.-butyl-2-(5-chloro-2H-benzotriazol-2-yl)-4-methylphenol, 2,4-di-tert-butyl-6-(5-chloro-2H-benzotriazol-2-yl)phenol, 2-(2H-benzotriazol-2-yl)-4,6-di-tert.-pentylphenol, 2-(2H-benzotriazol-2-yl)-4-(1,1,3,3-tetramethylbutyl)-phenol, 2-(2H-benzotriazol-2-yl)-4-methylphenol, 2-(2H-benzotriazol-2-yl)-4,6-bis(1-methyl-1-phenylethyl)phenol; b) cyanoacrylate derivatives, such as ethyl 2-cyano-3-phenylcinnamate (Uvinul® 3035, BASF SE), 2-cyano-3,3-diphenylacrylic acid-2′-ethylhexyl ester or 2-ethylhexyl 2-cyano-3-phenylcinnamate (octocrylene, Uvinul® 539 T, Uvinul 3039, BASF SE); c) para-aminobenzoic acid (PABA) derivatives, especially esters, such as ethyl-PABA, ethoxylated PABA, ethyl-dihydroxypropyl-PABA, Glycerol-PABA, 2-ethylhexyl 4-(dimethylamino)benzoate (Uvinur MC 80), 2-octyl-4-(dimethyl-amino)benzoate, amyl 4-(dimethylamino)benzoate, 4-bis(polyethoxy)-4-amino benzoic acid polyethoxyethyl ester (Uvinul® P 25, BASF SE); d) esters of salicylic acid, such as 2-ethylhexyl salicylate, 4-isopropylbenzyl salicylate, homomenthyl salicylate, TEA salicylate (Neo Heliopan® TS, Haarmann and Reimer), dipropyleneglycol salicylate; e) esters of cinnamic acid, such as 2-ethylhexyl 4-methoxycinnamate (Uvinul® MC 80), octyl-p-methoxycinnamate, propyl 4-methoxycinnamate, isoamyl-4-methoxycinnamate, conoxate, diisopropyl methylcinnamate, etocrylene (Uvinul® N 35, BASF SE); f) derivatives of benzophenone, such as 2-hydroxy-4-methoxybenzophenone (Uvinul® M 40, BASF SE), 2-hydroxy-4-methoxy-4′-methylbenzophenone, 2,2′-dihydroxy-4-methoxybenzophenone, 2-(4-diethylamino-2-hydroxy-benzoyl)-benzoic acid hexylester (Uvinul® A Plus, BASF SE), 4-n-octyloxy-2-hydroxybenzophenone (Uvinul® 3008, BASF SE), 2-hydroxybenophenone derivatives such as 4-hydroxy-, 4-methoxy-, 4-octyloxy-, 4-decyloxy-, 4-dodecyloxy-, 4-benzyloxy-, 4,2′,4′-trihydroxy-; 2′-hydroxy-4,4′-dimethoxy-2-hydroxybenzophenone; g) sulfonic acid derivatives of benzophenones, such as 2-hydroxy-4-methoxybenzo-phenone-5-sulfonic acid (Uvinul® MS 40, BASF SE) and its salts, 2,2′-dihydroxy-4,4′-dimethoxybenzophenone-5,5′-sulfonic acid and its salts (disodium salt: Uvinul® DS 49, BASF SE); h) 3-benzylidenecamphor and derivatives thereof, such as 3-(4′-methylbenzylidene)d-1-camphor, benzylidiene camphor sulfonic acid (Mexoryl® SO, Chimex); j) sulfonic acid derivatives of 3-benzylidenecamphor, such as 4-(2-oxo-3-bornylidenemethyl)benzenesulfonic acid and 2-methyl-5-(2-oxo-3-bornylidene)sulfonic acid and salts thereof; k) esters of benzalmalonic acid, such as 2-ethylhexyl 4-methoxybenzmalonate; m) triazine derivatives, such as dioctylbutamidotriazone (Uvasorb® HEB, Sigma), 2,4,6-trinanilino-p-(carbo-2′-ethyl-hexyl-1′-oxy)-1,3,5-triazine (Uvinul® T 150, BASF SE), 2-[4-[(2-Hydroxy-3-(2′-ethyl)hexyl)oxy]-2-hydroxyphenyl]-4,6bis(2,4-dimethylphenyl)-1,3,5-triazine (Tinuvin® 405, CIBA AG), anisotriazine (Tinosorb® S, CIBA AG), 2,4,6-tris(diisobutyl-4′-aminobenzalmalonate)-s-triazine; n) propane-1,3-diones, such as, 1-(4-tert-butylphenyl)-3-(4′-methoxyphenyl)propane-1,3-dione; o) 2-phenylbenzimidazole-5-sulfonic acid or 2-phenylbenzimidazole-4-sulfonic acid and alkali metal, alkaline earth metal, ammonium, alkylammonium, alkanolammonium and glucammonium salts thereof; p) derivatives of benzoylmethane, such as, 1-(4′-tert-butylphenyl)-3-(4′-methoxyphenyl)propane-1,3-dione, 4-tert-butyl-4′-methoxydibenzoylmethane or 1-phenyl-3-(4′-isopropylphenyl)propane-1,3-dione; q) aminohydroxy-substituited derivatives of benzophenones, such as N,N-diethylaminohydroxybenzoyl-n-hexylbenzoate; r) inorganic absorbers e.g. based on ZnO (e.g. Z-Cote® products, BASF SE), TiO₂ (e.g. T-Lite™ products, BASF SE) or CeO₂; and s) mixtures of UV filters of groups a) to r), such as a mixture of p-methoxycinnamic acid ethylhexyl ester (65%) and 2-(4-diethylamino-2-hydroxybenzoyl)benzoic acid hexylester (35%) (Uvinul® A Plus B, BASF SE);

Suitable tackifiers or binders are polyvinylpyrrolidons, polyvinylacetates, polyvinyl alcohols, polyacrylates, biological or synthetic waxes, and cellulose ethers.

The invention also relates to a method for controlling phytopathogenic fungi and/or undesired plant growth and/or undesired attack by insects or mites and/or for regulating the growth of plants, where the agrochemical formulation is allowed to act on the particular pests, their habitat or the plants to be protected from the particular pest, the soil and/or on undesired plants and/or the useful plants and/or their habitat. In one embodiment, the method is for controlling phytopathogenic fungi. In another embodiment, the method is for controlling undesired vegetation. In another embodiment, the method is for controlling undesired attach by insects or mites.

These methods typically comprise the treatment of the plant to be protected, its locus of growth, the phytopathogenic fungi and/or undesired plant growth and/or undesired attack by insects or mites with the agrochemical formulation.

Suitable methods of treatment include inter alia soil treatment, seed treatment, in furrow application, and foliar application. Soil treatment methods include drenching the soil, drip irrigation (drip application onto the soil), dipping roots, tubers or bulbs, or soil injection. Seed treatment techniques include seed dressing, seed coating, seed dusting, seed soaking, and seed pelleting. In furrow applications typically include the steps of making a furrow in cultivated land, seeding the furrow with seeds, applying the pesticidally active compound to the furrow, and closing the furrow.

In one embodiment of the method of application, the plant is an agricultural plant and/or the propagation material relates to propagation material of such agricultural plants, wherein the agricultural plant is selected from wheat, barley, oat, rye, soybean, corn, potatoes, oilseed rape, canola, sunflower, cotton, sugar cane, sugar beet, rice or a vegetable such as spinach, lettuce, asparagus, or cabbages; or sorghum; a silvicultural plant; an ornamental plant; and a horticultural plant, each in its natural or in a genetically modified form.

In one embodiment, the plant to be treated according to the method of the invention is an agricultural plant. “Agricultural plants” are plants of which a part (e.g. seeds) or all is harvested or cultivated on a commercial scale or which serve as an important source of feed, food, fibers (e.g. cotton, linen), combustibles (e.g. wood, bioethanol, biodiesel, biomass) or other chemical compounds. Preferred agricultural plants are for example cereals, e.g. wheat, rye, barley, triticale, oats, corn, sorghum or rice, beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, linseed, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola, sugar cane or oil palm; tobacco; nuts; coffee; tea; bananas; vines (table grapes and grape juice grape vines); hop; turf; natural rubber plants.

In a further embodiment, the plant to be treated according to the method of the invention is a horticultural plant. The term “horticultural plants” are to be understood as plants which are commonly used in horticulture, e.g. the cultivation of ornamentals, vegetables and/or fruits. Examples for ornamentals are turf, geranium, pelargonia, petunia, begonia and fuchsia. Examples for vegetables are potatoes, tomatoes, peppers, cucurbits, cucumbers, melons, watermelons, garlic, onions, carrots, cabbage, beans, peas and lettuce and more preferably from tomatoes, onions, peas and lettuce. Examples for fruits are apples, pears, cherries, strawberry, citrus, peaches, apricots and blueberries.

In a further embodiment, the plant to be treated according to the method of the invention is an ornamental plant. “Ornamental plants” are plants which are commonly used in gardening, e.g. in parks, gardens and on balconies. Examples are turf, geranium, pelargonia, petunia, begonia and fuchsia.

In another embodiment of the present invention, the plant to be treated according to the method of the invention is a silvicultural plant. The term “silvicultural plant” is to be understood as trees, more specifically trees used in reforestation or industrial plantations. Industrial plantations generally serve for the commercial production of forest products, such as wood, pulp, paper, rubber tree, Christmas trees, or young trees for gardening purposes. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch, oil palm, and oak.

When employed in plant protection, the amounts of agrochemical active applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

Advantages of the present invention are that no thickening agent is required, that no biocide is required, and that agrochemical actives that degrade over time in the presence of water can be stabilized as compared to formulations having a continuous aqueous phase.

The following examples illustrate the invention.

### Ingredients:

### Pesticide A: Saflufenacil

### Pesticide B: Metyltetraprole

Dispersant A: Polyoxyethylene sorbitol hexaoleate, 50 ethylene oxide moieties per molecule
Dispersant B: alkoxylated alcohol, melting point 26-31° C., dynamic viscosity 100 mPas at 50° C.
O/W-Emulsifier A: blend of calcium alkylarylsulfonate and of fatty alcohol ethoxylate
O/W-Emulsifier B: N,N-bishydroxyethylamides C₈-C₁₈-alykl carboxylic acids and/or unsaturated C₁₈ carboxylic acids
W/O-Emulsifier A: nonionic modified polyester, liquid, melting point 10° C., acid number up to 8 (mg KOH/g)
W/O-Emulsifier B: block copolymer of ethylene oxide and propylene oxide, containing 10 wt % of ethylene glycol; HLB value of 2.
W/O-Emulsifier C: castor oil ethoxylate, HLB of 7
W/O-Emulsifier D: castor oil ethoxylate, HLB of 10
W/O-Emulsifier E: castor oil, ethoxylated, oleate, dynamic viscosity 310 mPas at 25° C., acid number 10-14 mg KOH/g
W/O-Emulsifier F: castor oil, ethoxylated, oleate, dynamic viscosity 340 mPas at 20° C.
W/O-Emulsifier G: castor oil ethoxylate oleate, dynamic viscosity 470 mPas at 20° C., acid number below 10 mg KOH/g.
W/O-Emulsifier H: 12-hydroxystearic acid polyethylene glycol copolymer, minimum number average molecular weight 5,000 amu
W/O-Emulsifier J: polyglycerol fatty acid partial ester, liquid, density 0.98 g/ml at 20° C.
W/O-Emulsifier K: tridecylalcohol ethoxylate, 3 ethylene oxide moieties per molecule, HLB value of 8
W/O-Emulsifier L: block copolymer of ethylene oxide and propylene oxide, melting point −27° C., hydroxyl value 55.6 mg KOH/g
W/O-Emulsifier M: glyceryl caprylate caprate
W/O-Emulsifier N: hydroxy stearic acid polyglycerol ester
W/O-Emulsifier O: polyether siloxane, nonionic, viscosity at 25° C. 600-900 mPas
W/O-Emulsifier P: ethoxylated castor oil, HLB of 4
Solvent A: soybean oil methyl ester
Solvent B: soybean oil
Solvent C: aromatics depleted hydrocarbon solvent containing C₁₁-C₁₄ alkanes, isoalkanes, and cycloalkanes

### EXAMPLE-1

The agrochemical formulations AF-1 to AF-7 containing Pesticide A were prepared with the ingredients as indicated in Tables 1 and 2 as follows. The solvent was mixed with the pesticide, the dispersant and the O/W-emulsifier to a premix. Mixing was performed with an Ultra-Turrax IKA T18 device for 1.5 minutes at 16,000 rpm. A volume of 250 ml of the premix was then milled with a Getzmann basket mill at 3000 rpm for 20 minutes at a maximum temperature of 35° C. under addition of 28 ml of zirconium oxide beads with a diameter of 1.0 to 1.2 mm to a raw suspension. Subsequently, the W/O-emulsifier was added to the raw suspension and the resulting composition was again mixed with the Ultra-Turrax device at 5,000 rpm under the addition of water. After the complete amount of water had been added, the agrochemical formulation was mixed with the Ultra-Turrax device for another two minutes at 5,000 rpm.

TABLE 1
Ingredients of agrochemical formulations AF-1 to AF-4 in [%] w/w

Ingredient Formulation

| | AF-1 | AF-2 | AF-3 | AF-4 |
|---|---|---|---|---|
| Pesticide A | 10 | 10 | 10 | 10 |
| Dispersant A | 10 | 10 | 10 | 10 |
| O/W-Emulsifier A | 5 | 5 | 5 | 5 |
| W/O-Emulsifier A | 5 | — | 5 | — |
| W/O-Emulsifier B | — | 5 | — | — |
| W/O-Emulsifier C | — | — | — | 5 |
| W/O-Emulsifier D | — | — | — | — |
| W/O-Emulsifier E | | | | |
| W/O-Emulsifier F | — | — | — | — |
| Water | 15 | 25 | 25 | 25 |
| Solvent A | 55 | 45 | 45 | 45 |

TABLE 2
Ingredients of agrochemical formulations AF-5 to AF-7 in [%] w/w

| | Ingredient Formulation | | |
|---|---|---|---|
| | AF-5 | AF-6 | AF-7 |
| Pesticide A | 10 | 10 | 10 |
| Dispersant A | 10 | 10 | 10 |
| O/W-Emulsifier A | 5 | 5 | 5 |
| W/O-Emulsifier A | — | — | — |
| W/O-Emulsifier B | — | — | — |
| W/O-Emulsifier C | — | — | — |
| W/O-Emulsifier D | 5 | — | — |
| W/O-Emulsifier E | — | 5 | — |
| W/O-Emulsifier F | — | — | 5 |
| Water | 25 | 25 | 25 |
| Solvent A | 45 | 45 | 45 |

### EXAMPLE-2

The agrochemical formulations AF-8 to AF-26 containing Pesticide B were prepared with the ingredients as indicated in Tables 3 to 7 in analogy to Example-1.

TABLE 3
Ingredients of agrochemical formulations
AF-8 to AF-11 in [%] w/w

Ingredient Formulation

| | AF-8 | AF-9 | AF-10 | AF-11 |
|---|---|---|---|---|
| Pesticide B | 10 | 10 | 10 | 10 |
| Dispersant B | 10 | 10 | 10 | 10 |
| O/W-Emulsifier B | 5 | 5 | 5 | 5 |
| W/O-Emulsifier G | — | — | 5 | — |
| W/O-Emulsifier H | 5 | — | — | 5 |
| W/O-Emulsifier A | — | 5 | — | — |
| Water | 5 | 5 | 10 | 10 |
| Solvent B | 43.33 | 43.33 | 40 | 40 |
| Solvent C | 21.66 | 21.66 | 20 | 20 |

TABLE 4
Ingredients of agrochemical formulations
AF-12 to AF-15 in [%] w/w

Ingredient Formulation

| | AF-12 | AF-13 | AF-14 | AF-15 |
|---|---|---|---|---|
| Pesticide B | 10 | 10 | 10 | 10 |
| Dispersant B | 10 | 10 | 10 | 10 |
| O/W-Emulsifier B | 5 | 5 | 5 | 5 |
| W/O-Emulsifier K | 5 | — | — | — |
| W/O-Emulsifier L | — | 5 | — | — |
| W/O-Emulsifier G | — | — | 5 | — |
| W/O-Emulsifier J | — | — | — | 5 |
| Water | 10 | 10 | 15 | 15 |
| Solvent B | 40 | 40 | 36.7 | 36.7 |
| Solvent C | 20 | 20 | 18.3 | 18.3 |

TABLE 5
Ingredients of agrochemical formulations
AF-16 to AF-18 in [%] w/w

Ingredient Formulation

| | AF-16 | AF-17 | AF-18 | AF-19 |
|---|---|---|---|---|
| Pesticide B | 10 | 10 | 10 | 10 |
| Dispersant B | 10 | 10 | 10 | 10 |
| O/W-Emulsifier B | 5 | 5 | 5 | 5 |
| W/O-Emulsifier L | 5 | — | — | — |
| W/O-Emulsifier M | — | 5 | — | — |
| W/O-Emulsifier N | — | — | 5 | — |
| W/O-Emulsifier G | — | — | — | 10 |
| Water | 15 | 15 | 15 | 10 |
| Solvent B | 36.7 | 36.7 | 36.7 | 36.7 |
| Solvent C | 18.3 | 18.3 | 18.3 | 18.3 |

TABLE 6
Ingredients of agrochemical formulations
AF-8 to AF-11 in [%] w/w

Ingredient Formulation

| | AF-20 | AF-21 | AF-22 | AF-23 |
|---|---|---|---|---|
| Pesticide B | 10 | 10 | 10 | 10 |
| Dispersant B | 10 | 10 | 10 | 10 |
| O/W-Emulsifier B | 5 | 5 | 5 | 5 |
| W/O-Emulsifier A | 10 | — | — | — |
| W/O-Emulsifier K | — | 10 | — | — |
| W/O-Emulsifier N | — | — | 10 | — |
| W/O-Emulsifier G | — | — | — | 10 |
| Water | 10 | 10 | 10 | 15 |
| Solvent B | 36.7 | 36.7 | 36.7 | 33.3 |
| Solvent C | 18.3 | 18.3 | 18.3 | 16.7 |

TABLE 7
Ingredients of agrochemical formulations
AF-23 to AF-26 in [%] w/w

| | Ingredient Formulation | | |
|---|---|---|---|
| | AF-24 | AF-25 | AF-26 |
| Pesticide B | 10 | 10 | 10 |
| Dispersant B | 10 | 10 | 10 |
| O/W-Emulsifier B | 5 | 5 | 5 |
| W/O-Emulsifier N | 10 | — | 10 |
| W/O-Emulsifier G | — | 10 | — |
| Water | 15 | 20 | 20 |
| Solvent B | 33.3 | 30 | 30 |
| Solvent C | 16.7 | 15 | 15 |

### EXAMPLE 3

The agrochemical formulations AF-1 to AF-26 were stored at 20 to 25° C. for two months and analyzed for their storage stability by visual inspection. None of the formulations showed the formation of any sediment or phase separation.

### EXAMPLE-4

The agrochemical formulations AF-27 to AF-34 were prepared with the ingredients as indicated in Tables 8 to 10 in analogy to Example-1.

TABLE 8
Ingredients of agrochemical formulations
AF-27 to AF-29 in [%] w/w

| | Ingredient Formulation | | |
|---|---|---|---|
| | AF-27 | AF-28 | AF-29 |
| Pesticide A | 10 | 10 | 10 |
| Dispersant A | 10 | 10 | 10 |
| O/W-Emulsifier A | 5 | 5 | 5 |
| W/O-Emulsifier A | 5 | — | — |
| W/O-Emulsifier B | — | 5 | — |
| W/O-Emulsifier E | — | — | 5 |
| Water | 25 | 25 | 25 |
| Solvent A | 45 | 45 | 45 |

TABLE 9
Ingredients of agrochemical formulations
AF-30 to AF-31 in [%] w/w

Ingredient Formulation

| | AF-30 | AF-31 |
|---|---|---|
| Pesticide B | 10 | 10 |
| Dispersant B | 10 | 10 |
| O/W-Emulsifier B | 5 | 5 |
| W/O-Emulsifier G | 5 | — |
| W/O-Emulsifier J | — | 5 |
| Water | 15 | 15 |
| Solvent B | 36.7 | 36.7 |
| Solvent C | 18.3 | 18.3 |

TABLE 10
Ingredients of agrochemical formulations
AF-32 to AF-34 in [%] w/w

| | Ingredient Formulation | | |
|---|---|---|---|
| | AF-32 | AF-33 | AF-34 |
| Pesticide B | 10 | 10 | 10 |
| Dispersant B | 10 | — | — |
| Dispersant A | — | 10 | 10 |
| O/W-Emulsifier B | 5 | — | — |
| O/W-Emulsifier A | — | 5 | 5 |
| W/O-Emulsifier L | 5 | — | — |
| W/O-Emulsifier B | — | 5 | — |
| W/O-Emulsifier E | — | — | 5 |
| Water | 15 | 25 | 25 |
| Solvent B | 33.3 | 30 | 30 |
| Solvent C | 16.7 | 15 | 15 |

### EXAMPLE 5: VISCOSITY MEASUREMENT

The dynamic viscosities of the agrochemical formulations AF-1 to AF-26 in Examples 1, and 2 were determined. The measurements were carried out with the rheometer AR 2000 ex from TA instruments at 20° C. The rheometer had a cone-plate geometry with an angle between the surface of the cone and the plate of 1°. A volume of 2 to 3 ml of the agrochemical formulation to be measured was put on the plate, upon which the cone was brought onto the plate. The data of the shear stress was recorded at 20° C. at increasing shear rates up to 200 per second.
The true viscosity was calculated as the slope of the tangent of the resulting experimental curve at a shear rate of 100 per second. The apparent viscosity was calculated by dividing the shear stress at a shear rate of 100 per second by the shear rate. The apparent viscosity and the true viscosity are equal for Newtonian fluids. Tables 11 to 14 summarized the measured data.

TABLE 11
True and Apparent Viscosity values for
agrochemical formulations AF-1 to AF-7

| Viscosity | AF-1 | AF-2 | AF-3 | AF-4 | AF-5 | AF-6 | AF-7 |
|---|---|---|---|---|---|---|---|
| True Viscosity | 178 | 101 | 336 | 265 | 280 | 164 | 276 |
| [mPas] | | | | | | | |
| Apparent Viscosity | 427 | 245 | 597 | 650 | 546 | 387 | 695 |
| [mPas] | | | | | | | |

TABLE 12
True and Apparent Viscosity values for agrochemical formulations AF-8 to AF-14

| Viscosity | AF-8 | AF-9 | AF-10 | AF-11 | AF-12 | AF-13 | AF-14 |
|---|---|---|---|---|---|---|---|
| True Viscosity | 328 | 129 | 391 | 570 | 223 | 100 | 139 |
| [mPas] | | | | | | | |
| Apparent Viscosity | 524 | 301 | 584 | 955 | 381 | 189 | 371 |
| [mPas] | | | | | | | |

TABLE 13
True and Apparent Viscosity values for agrochemical
formulations AF-15 to AF-21

| Viscosity | AF-15 | AF-16 | AF-17 | AF-18 | AF-19 | AF-20 | AF-21 |
|---|---|---|---|---|---|---|---|
| True Viscosity | 600 | 780 | 185 | 98 | 288 | 481 | 187 |
| [mPas] | | | | | | | |
| Apparent Viscosity | 881 | 1516 | 256 | 173 | 485 | 652 | 285 |
| [mPas] | | | | | | | |

TABLE 14
True and Apparent Viscosity values for agrochemical
formulations AF-22 to AF-26

| Viscosity | AF-22 | AF-23 | AF-24 | AF-25 | AF-26 |
|---|---|---|---|---|---|
| True Viscosity | 497 | 344 | 718 | 418 | 877 |
| [mPas] | | | | | |
| Apparent Viscosity | 669 | 680 | 902 | 628 | 1183 |
| [mPas] | | | | | |

### EXAMPLE 6: PARTICLE SIZE DISTRIBUTION

The particle size distribution of the samples AF-27 to AF-34 was analyzed directly after preparation, and after 2 weeks of incubation at 0° C. or 54° C. The measurement was carried out on a Malvern Mastersizer 2000 by Malvern Instruments GmbH. A sample of the respective agrochemical formulation to be measured was diluted in an excess of water and analyzed by laser diffraction in a range of from 0.1 to 2000 μm. The results as compiled in Table 15 reflected the size of oil droplets formed upon the dilution in water, and the size of the pesticide particles in the agrochemical formulation.

TABLE 15
D50 values for agrochemical formulations AF-27 to AF-34 in μm directly after
preparation (“No storage”), after 2 weeks at 0° C.. or after 2 weeks at 54° C.

| Storage condition | AF-28 | AF-29 | AF-30 | AF-31 | AF-32 | AF-33 | AF-34 |
|---|---|---|---|---|---|---|---|
| No storage | 2.72 | 4.1 | 2.38 | 4.95 | 5.79 | 1.85 | 2.01 |
| 2 weeks at | 3.82 | 3.81 | 4.04 | 7.5 | 7.66 | 3.75 | 4.33 |
| 0° C. | | | | | | | |
| 2 weeks at | 2.88 | 3.01 | 2.46 | 8.2 | — | 1.92 | 2.09 |
| 54° C. | | | | | | | |

Visual inspection of the samples AF-28 to AF-34 showed no phase separation under the conditions as outlined above. The D50 values of all samples were in an acceptable range.

### COMPARATIVE EXAMPLE 1

An oil dispersion OD-1 containing Pesticide B but no water droplets was prepared with the ingredients as indicated in Table 16 as follows. The solvent was mixed with the pesticide, the dispersant and the O/W-emulsifier to a premix. Mixing was performed with an Ultra-Turrax IKA T18 device for 1.5 minutes at 16,000 rpm. A volume of 250 ml of the premix was then milled with a Getzmann basket mill at 3000 rpm for 20 minutes at a maximum temperature of 35° C. under addition of 28 ml of zirconium oxide beads with a diameter of 1.0 to 1.2 mm to the final formulation OD-1.

TABLE 16
Ingredients of OD-1 in [% w/w]

| Ingredient Formulation | OD-1 |
|---|---|
| Pesticide B | 10 |
| Dispersant B | 10 |
| O/W-Emulsifier B | 5 |
| Solvent B | 50 |
| Solvent C | 25 |

### COMPARATIVE EXAMPLE 2

The dynamic viscosity of OD-1 was measured in analogy to Example 5. The true viscosity was determined to be 39.8 mPas, the apparent viscosity was measured as 44.5 mPas. These results showed that the viscosity of an oil dispersion without the addition of water droplets is considerably reduced.

### EXAMPLE-7

The agrochemical formulations AF-35 to AF-45 were prepared with the ingredients as indicated in Tables 17 to 19 in analogy to Example-1.

TABLE 17
Ingredients of agrochemical formulations
AF-35 to AF-38 in [%] w/w

Ingredient Formulation

| | AF-35 | AF-36 | AF-37 | AF-38 |
|---|---|---|---|---|
| Pesticide A | 10 | 10 | 10 | 10 |
| Dispersant A | 10 | 10 | 10 | 10 |
| O/W-Emulsifier A | 5 | 5 | 5 | 5 |
| W/O-Emulsifier G | 5 | — | — | — |
| W/O-Emulsifier B | — | 5 | — | — |
| W/O-Emulsifier J | — | — | 5 | — |
| W/O-Emulsifier O | — | — | — | 5 |
| W/O-Emulsifier A | — | — | — | — |
| W/O-Emulsifier P | — | — | — | — |
| W/O-Emulsifier C | — | — | — | — |
| W/O-Emulsifier D | — | — | — | — |
| W/O-Emulsifier E | — | — | — | — |
| W/O-Emulsifier F | — | — | — | — |
| W/O-Emulsifier N | — | — | — | — |
| Water | 20 | 20 | 20 | 20 |
| Solvent A | 50 | 50 | 50 | 50 |

TABLE 18
Ingredients of agrochemical formulations
AF-39 to AF-42 in [%] w/w

Ingredient Formulation

| | AF-39 | AF-40 | AF-41 | AF-42 |
|---|---|---|---|---|
| Pesticide A | 10 | 10 | 10 | 10 |
| Dispersant A | 10 | 10 | 10 | 10 |
| O/W-Emulsifier A | 5 | 5 | 5 | 5 |
| W/O-Emulsifier G | — | — | — | — |
| W/O-Emulsifier B | — | — | — | — |
| W/O-Emulsifier J | — | — | — | — |
| W/O-Emulsifier O | — | — | — | — |
| W/O-Emulsifier A | 5 | — | — | — |
| W/O-Emulsifier P | — | 5 | — | — |
| W/O-Emulsifier C | — | — | 5 | — |
| W/O-Emulsifier D | — | — | — | 5 |
| W/O-Emulsifier E | — | — | — | — |
| W/O-Emulsifier F | — | — | — | — |
| W/O-Emulsifier N | — | — | — | — |
| Water | 20 | 20 | 20 | 20 |
| Solvent A | 50 | 50 | 50 | 50 |

TABLE 19
Ingredients of agrochemical formulations
AF-43 to AF-45 in [%] w/w

| | Ingredient Formulation | | |
|---|---|---|---|
| | AF-43 | AF-44 | AF-45 |
| Pesticide A | 10 | 10 | 10 |
| Dispersant A | 10 | 10 | 10 |
| O/W-Emulsifier A | 5 | 5 | 5 |
| W/O-Emulsifier G | — | — | — |
| W/O-Emulsifier B | — | — | — |
| W/O-Emulsifier J | — | — | — |
| W/O-Emulsifier O | — | — | — |
| W/O-Emulsifier A | — | — | — |
| W/O-Emulsifier P | — | — | — |
| W/O-Emulsifier C | — | — | — |
| W/O-Emulsifier D | — | — | — |
| W/O-Emulsifier E | 5 | — | — |
| W/O-Emulsifier F | — | 5 | — |
| W/O-Emulsifier N | — | — | 5 |
| Water | 20 | 20 | 20 |
| Solvent A | 50 | 50 | 50 |

### EXAMPLE-8

The agrochemical formulations AF-46 to AF-56 were prepared with the ingredients as indicated in Tables 20 to 22 in analogy to Example-1.

TABLE 20
Ingredients of agrochemical formulations
AF-46 to AF-49 in [%] w/w

Ingredient Formulation

| | AF-46 | AF-47 | AF-48 | AF-49 |
|---|---|---|---|---|
| Pesticide A | 10 | 10 | 10 | 10 |
| Dispersant A | 10 | 10 | 10 | 10 |
| O/W-Emulsifier A | 5 | 5 | 5 | 5 |
| W/O-Emulsifier G | 5 | — | — | — |
| W/O-Emulsifier B | — | 5 | — | — |
| W/O-Emulsifier J | — | — | 5 | — |
| W/O-Emulsifier O | — | — | — | 5 |
| W/O-Emulsifier A | — | — | — | — |
| W/O-Emulsifier P | — | — | — | — |
| W/O-Emulsifier C | — | — | — | — |
| W/O-Emulsifier D | — | — | — | — |
| W/O-Emulsifier E | — | — | — | — |
| W/O-Emulsifier F | — | — | — | — |
| W/O-Emulsifier N | — | — | — | — |
| Water | 25 | 25 | 25 | 25 |
| Solvent A | 45 | 45 | 45 | 45 |

TABLE 21
Ingredients of agrochemical formulations
AF-50 to AF-53 in [%] w/w

Ingredient Formulation

| | AF-50 | AF-51 | AF-52 | AF-53 |
|---|---|---|---|---|
| Pesticide A | 10 | 10 | 10 | 10 |
| Dispersant A | 10 | 10 | 10 | 10 |
| O/W-Emulsifier A | 5 | 5 | 5 | 5 |
| W/O-Emulsifier G | — | — | — | — |
| W/O-Emulsifier B | — | — | — | — |
| W/O-Emulsifier J | — | — | — | — |
| W/O-Emulsifier O | — | — | — | — |
| W/O-Emulsifier A | 5 | — | — | — |
| W/O-Emulsifier P | — | 5 | — | — |
| W/O-Emulsifier C | — | — | 5 | — |
| W/O-Emulsifier D | — | — | — | 5 |
| W/O-Emulsifier E | — | — | — | — |
| W/O-Emulsifier F | — | — | — | — |
| W/O-Emulsifier N | — | — | — | — |
| Water | 25 | 25 | 25 | 25 |
| Solvent A | 45 | 45 | 45 | 45 |

TABLE 22
Ingredients of agrochemical formulations
AF-54 to AF-56 in [%] w/w

| | Ingredient Formulation | | |
|---|---|---|---|
| | AF-54 | AF-55 | AF-56 |
| Pesticide A | 10 | 10 | 10 |
| Dispersant A | 10 | 10 | 10 |
| O/W-Emulsifier A | 5 | 5 | 5 |
| W/O-Emulsifier G | — | — | — |
| W/O-Emulsifier B | — | — | — |
| W/O-Emulsifier J | — | — | — |
| W/O-Emulsifier O | — | — | — |
| W/O-Emulsifier A | — | — | — |
| W/O-Emulsifier P | — | — | — |
| W/O-Emulsifier C | — | — | — |
| W/O-Emulsifier D | — | — | — |
| W/O-Emulsifier E | 5 | — | — |
| W/O-Emulsifier F | — | 5 | — |
| W/O-Emulsifier N | — | — | 5 |
| Water | 25 | 25 | 25 |
| Solvent A | 45 | 45 | 45 |

### EXAMPLE 9: VISCOSITY MEASUREMENT

The dynamic viscosities of the agrochemical formulations AF-35 to AF-56 in Examples 7 and 8 were determined directly after production of the formulations. The measurements were carried out with the rheometer AR 2000 ex from TA instruments at 20° C. The rheometer had a cone-plate geometry with an angle between the surface of the cone and the plate of 1°. A volume of 2 to 3 ml of the agrochemical formulation to be measured was put on the plate, upon which the cone was brought onto the plate. The data of the shear stress was recorded at 20° C. at increasing shear rates up to 200 per second.

The true viscosity was calculated as the slope of the tangent of the resulting experimental curve at a shear rate of 100 per second. The apparent viscosity was calculated by dividing the shear stress at a shear rate of 100 per second by the shear rate. The apparent viscosity and the true viscosity are equal for Newtonian fluids. Tables 23 to 26 summarized the measured data.

TABLE 23
True and Apparent Viscosity values for agrochemical formulations
AF-35 to AF-41 measured directly after production.

| Viscosity | AF-35 | AF-36 | AF-37 | AF-38 | AF-39 | AF-40 | AF-41 |
|---|---|---|---|---|---|---|---|
| True Viscosity | 97.29 | 76.03 | 86.66 | 66.10 | 178.1 | 86.59 | 92.95 |
| [mPas] | | | | | | | |
| Apparent Viscosity | 157.7 | 142.1 | 86.66 | 115.1 | 426.9 | 118.9 | 140.5 |
| [mPas] | | | | | | | |

TABLE 24
True and Apparent Viscosity values for agrochemical formulations
AF-42 to AF-48 measured directly after production.

| Viscosity | AF-42 | AF-43 | AF-44 | AF-45 | AF-46 | AF-47 | AF-48 |
|---|---|---|---|---|---|---|---|
| True Viscosity | 146 | 92.14 | 86.33 | 103.9 | 252.6 | 101.1 | 183.7 |
| [mPas] | | | | | | | |
| Apparent Viscosity | 331.3 | 151 | 150.5 | 134.6 | 680.8 | 245 | 183.7 |
| [mPas] | | | | | | | |

TABLE 25
True and Apparent Viscosity values for agrochemical formulations
AF-49 to AF-55 measured directly after production

| Viscosity | AF-49 | AF-50 | AF-51 | AF-52 | AF-53 | AF-54 | AF-55 |
|---|---|---|---|---|---|---|---|
| True Viscosity | 149.4 | 335.6 | 67.92 | 265 | 280.2 | 163.6 | 275.5 |
| [mPas] | | | | | | | |
| Apparent Viscosity | 317.6 | 597.2 | 151.8 | 650.1 | 546.8 | 386.5 | 695.1 |
| [mPas] | | | | | | | |

TABLE 26
True and Apparent Viscosity values for agrochemical
formulation AF-56 measured directly after production.

| Viscosity | AF-56 |
|---|---|
| True Viscosity | 98.42 |
| [mPas] | |
| Apparent Viscosity | 174 |
| [mPas] | |

### EXAMPLE 10: VISCOSITY MEASUREMENT

The dynamic viscosities of the agrochemical formulations AF-35 to AF-56 in Examples 7 and 8 were determined after 14 days of storage at 54° C. after production of the formulations. The measurements were carried out with the rheometer AR 2000 ex from TA instruments at 20° C. The rheometer had a cone-plate geometry with an angle between the surface of the cone and the plate of 1°. A volume of 2 to 3 ml of the agrochemical formulation to be measured was put on the plate, upon which the cone was brought onto the plate. The data of the shear stress was recorded at 20° C. at increasing shear rates up to 200 per second.

The true viscosity was calculated as the slope of the tangent of the resulting experimental curve at a shear rate of 100 per second. The apparent viscosity was calculated by dividing the shear stress at a shear rate of 100 per second by the shear rate. The apparent viscosity and the true viscosity are equal for Newtonian fluids. Tables 27 to 30 summarized the measured data.

TABLE 27
True and Apparent Viscosity values for agrochemical formulations
AF-35 to AF-41 after 14 days of incubation.

| Viscosity | AF-35 | AF-36 | AF-37 | AF-38 | AF-39 | AF-40 | AF-41 |
|---|---|---|---|---|---|---|---|
| True Viscosity | 93.45 | 79.23 | 85.76 | 68.23 | 181.5 | 90.15 | 95.88 |
| [mPas] | | | | | | | |
| Apparent Viscosity | 145.1 | 150.9 | 85.76 | 120.2 | 446.7 | 120.4 | 145.7 |
| [mPas] | | | | | | | |

TABLE 28
True and Apparent Viscosity values for agrochemical formulations
AF-42 to AF-48 after 14 days of incubation.

| Viscosity | AF-42 | AF-43 | AF-44 | AF-45 | AF-46 | AF-47 | AF-48 |
|---|---|---|---|---|---|---|---|
| True Viscosity | 150.2 | 97.75 | 85.58 | 109.4 | 250.7 | 100.3 | 185.2 |
| [mPas] | | | | | | | |
| Apparent Viscosity | 320.8 | 156.9 | 155.1 | 139.3 | 688.8 | 250.4 | 185.2 |
| [mPas] | | | | | | | |

TABLE 29
True and Apparent Viscosity values for agrochemical formulations
AF-49 to AF-55 after 14 days of incubation.

| Viscosity | AF-49 | AF-50 | AF-51 | AF-52 | AF-53 | AF-54 | AF-55 |
|---|---|---|---|---|---|---|---|
| True Viscosity | 145.6 | 340.4 | 70.73 | 250.6 | 285.2 | 170.1 | 280.3 |
| [mPas] | | | | | | | |
| Apparent Viscosity | 320.4 | 588.8 | 155.7 | 655.9 | 550.1 | 390.9 | 701.6 |
| [mPas] | | | | | | | |

TABLE 30
True and Apparent Viscosity values for agrochemical
formulation AF-56 after 14 days of incubation.

| Viscosity | AF-56 |
|---|---|
| True Viscosity [mPas] | 101.8 |
| Apparent Viscosity [mPas] | 183.2 |

### EXAMPLE 11: PARTICLE SIZE DISTRIBUTION

The particle size distribution of the samples AF-35 to AF-56 from Examples 7 and 8 was analyzed directly after preparation, and after 2 weeks of incubation at 54° C. The measurement was carried out on a Malvern Mastersizer 2000 by Malvern Instruments GmbH. A sample of the respective agrochemical formulation to be measured was diluted in an excess of water and analyzed by laser diffraction in a range of from 0.1 to 2000 μm. The results as compiled in Tables 31 to 34 reflected the size of oil droplets formed upon the dilution in water, and the size of the pesticide particles in the agrochemical formulation.

TABLE 31
D50 values for agrochemical formulations AF-35 to AF-41 in μm directly after
preparation (“No storage”), after 14 days at 20° C.

| Storage condition | AF-35 | AF-36 | AF-37 | AF-38 | AF-39 | AF-40 | AF-41 |
|---|---|---|---|---|---|---|---|
| No storage | 2.05 | 2.06 | 5.04 | 2.76 | 1.86 | 1.93 | 1.77 |
| 14 days at | 2.32 | 2.29 | 6.03 | 3.03 | 2.36 | 1.92 | 1.95 |
| 20° C. | | | | | | | |

TABLE 32
D50 values for agrochemical formulations AF-42 to AF-48 in μm directly after
preparation (“No storage”), after 14 days at 20° C.

| Storage condition | AF-42 | AF-43 | AF-44 | AF-45 | AF-46 | AF-47 | AF-48 |
|---|---|---|---|---|---|---|---|
| No storage | 1.94 | 1.53 | 1.98 | 2.42 | 2.01 | 2.05 | 4.58 |
| 14 days at | 2.23 | 1.75 | 2.33 | 2.71 | 2.23 | 2.4 | 5.04 |
| 20° C. | | | | | | | |

TABLE 33
D50 values for agrochemical formulations AF-50 to AF-56 in μm directly after
preparation (“No storage”), after 14 days at 20° C.

| Storage condition | AF-49 | AF-50 | AF-51 | AF-52 | AF-53 | AF-54 | AF-55 |
|---|---|---|---|---|---|---|---|
| No storage | 2.12 | 1.96 | 1.44 | 1.95 | 1.95 | 2.02 | 2.11 |
| 14 days at | 2.53 | 2.36 | 1.63 | 2.39 | 2.37 | 2.33 | 2.4 |
| 20° C. | | | | | | | |

TABLE 34
D50 values for agrochemical formulations AF-50
to AF-56 in μm directly after preparation (“No
storage”), after 14 days at 20° C.

| Storage condition | AF-56 |
|---|---|
| No storage | 2.12 |
| 14 days at 20° C. | 2.53 |

### EXAMPLE 12: PHASE SEPARATION

The samples AF-35 to AF-56 were stored at 54° C. in transparent bottles without shaking or stirring for 14 days. Subsequently, the phase separation of the samples was analyzed. To this end, the height of the supernatant was measured and compared to the total filling height. The relative phase separation was calculated by dividing the height of the supernatant phase to the total filling height. The results are summarized in Tables 35 to 38.

TABLE 35
Relative phase separation of formulations AF-35
to AF-40 after 2 weeks of incubation at 54° C.

| Formulation | AF-35 | AF-36 | AF-37 | AF-38 | AF-39 | AF-40 |
|---|---|---|---|---|---|---|
| Relative phase | 22 | 8 | 71 | 28 | 0 | 46 |
| separation [%] | | | | | | |

TABLE 36
Relative phase separation of formulations AF-41
to AF-46 after 2 weeks of incubation at 54° C.

| Formulation | AF-41 | AF-42 | AF-43 | AF-44 | AF-45 | AF-46 |
|---|---|---|---|---|---|---|
| Relative phase | 29 | 1 | 28 | 22 | 39 | 22 |
| separation [%] | | | | | | |

TABLE 37
Relative phase separation of formulations AF-48
to AF-52 after 2 weeks of incubation at 54° C.

| Formulation | AF-47 | AF-48 | AF-49 | AF-50 | AF-51 | AF-52 |
|---|---|---|---|---|---|---|
| Relative phase | 0 | 43 | 20 | 0 | 14 | 0 |
| separation [%] | | | | | | |

TABLE 38
Relative phase separation of formulations AF-53
to AF-56 after 2 weeks of incubation at 54° C.

| Formulation | AF-53 | AF-54 | AF-55 | AF-56 |
|---|---|---|---|---|
| Relative phase | 0 | 0 | 0 | 23 |
| separation [%] | | | | |

Visual inspection of the samples AF-35 to AF-56 showed no sediment after 2 weeks of incubation at 54° C.
Surprisingly, samples that displayed phase separation could be easily homogenized by inversion of the bottles containing them.

1. An agrochemical formulation comprising
a) a continuous oil phase comprising a water-immiscible solvent;
b) an agrochemical active in the form of particles, which particles are suspended in the continuous oil phase; and
c) water droplets that are emulsified in the continuous oil phase;
wherein the agrochemical formulation is substantially free of a thickener.

2. The agrochemical formulation of claim 1, containing at least 1 wt % of water based on the total weight of the agrochemical formulation.

3. The agrochemical formulation of claim 1, wherein the particles have a mean diameter of from 0.5 to 10 μm.

4. The agrochemical formulation of claim 1, comprising a dispersant.

5. The agrochemical formulation of claim 1, comprising a water-in-oil emulsifier.

6. The agrochemical formulation of claim 1, comprising an oil-in-water emulsifier.

7. The agrochemical formulation of claim 1, wherein the agrochemical active is selected from the group consisting of herbicides, fungicides, insecticides, nematicides, plant growth regulators, fertilizers, nitrification inhibitors, and urease inhibitors.

8. The agrochemical formulation of claim 1, wherein the continuous oil phase comprises a water-immiscible solvent selected from the group consisting of hydrocarbon solvents, vegetable oils, fatty acid esters, methyl- or ethyl esters of vegetable oils, and mixtures thereof.

9. The agrochemical formulation of claim 8, wherein the water-immiscible solvent has a water-solubility of up to 10 g/l at 20° C.

10. The agrochemical formulation of claim 1, wherein the water-droplets have a mean diameter of up to 25 μm.

11. The agrochemical formulation of claim 1 comprising the water-immiscible solvent in a concentration of from 20 to 80 wt % based on the total weight of the agrochemical formulation.

12. The agrochemical formulation of claim 1 comprising the agrochemical active in a concentration of from 1 to 60 wt % based on the total weight of the agrochemical formulation.

13. The agrochemical formulation according to claim 1, wherein the thickener increases a dynamic viscosity of the agrochemical formulation of at least 10 mPas at 25° C., when the thickener is present at a concentration of 1 wt % based on the total weight of the agrochemical formulation.

14. A method for preparing the agrochemical formulation as defined in claim 1, comprising
a) providing a premix by contacting the agrochemical active and the water-immiscible solvent;
b) milling the premix to form a raw suspension; and
c) emulsifying water in the raw suspension.

15. A method for controlling phytopathogenic fungi and/or undesired plant growth and/or undesired attack by particular pests and/or for regulating the growth of plants, where the agrochemical formulation as defined in claim 1 is allowed to act on the particular pests, their habitat or the plants to be protected from the particular pests, the soil and/or on undesired plants and/or the useful plants and/or their habitat.

16. The method of claim 15 wherein the particular pests are insects or mites.
